(19) United States
(12) Patent Application Publication
(10) Pub. No.: US 2016/0107385 A1
(43) Pub. Date: Apr. 21, 2016

(54) THREE-DIMENSIONAL SHAPED OBJECT MANUFACTURING METHOD AND THREE-DIMENSIONAL SHAPED OBJECT

(71) Applicant: SEIKO EPSON CORPORATION, Tokyo (JP)

(72) Inventors: Tomoaki TAKAHASHI, Matsumoto (JP); Toshimitsu HIRAI, Hokuto (JP)

(21) Appl. No.: 14/870,698

(22) Filed: Sep. 30, 2015

(30) Foreign Application Priority Data
Oct. 17, 2014 (JP) 2014-212386

(51) Int. Cl. B29C 67/00

(52) U.S. Cl. CPC B29C 67/0081; B29K 2105/251

(57) ABSTRACT

A three-dimensional shaped object manufacturing method of the invention is a three-dimensional shaped object manufacturing method for manufacturing a three-dimensional shaped object by laminating layers, including: a layer forming step of forming each of the layers by using a layer-forming composition containing particles and a solvent; a first liquid application step of applying, onto the layer in a state of containing the solvent, a liquid that is used to form a solidified part; and a solvent removal step of removing the solvent from the layer. In the first liquid application step, it is preferable that the liquid is applied to a surface of the layer containing the solidified part, in a region that does not overlap the solidified part when the layer is seen in plan view.

### BACKGROUND

1. Technical Field

The present invention relates to a three-dimensional shaped object manufacturing method, and a three-dimensional shaped object.

2. Related Art

There is known a technique for forming powder layers (layers) using a composition containing powders (particles) and laminating these layers to shape a three-dimensional shaped object (see, e.g., JP-A-6-218712). According to this technique, a three-dimensional shaped object is shaped by repeating the following operation. First, powders are thinly spread in a uniform thickness to form a powder layer, and a binding agent material (liquid) is applied only to the desired portion of this powder layer to allow the powders (particles) to be bound together, thus forming a bound part. As a result, a thin plate-shaped member (hereinafter referred to as “cross-sectional member”) is formed in the bound part in which the powders are bound together. Thereafter, an additional powder layer is thinly formed on the powder layer, and the powders are selectively bound together only in the desired portion, thus forming a bound part. As a result, a new cross-sectional member is also formed on the newly formed powder layer. At this time, the newly formed cross-sectional member is also bound to the previously formed cross-sectional member. A three-dimensional shaped object can be shaped by laminating thin plate-shaped cross-sectional members (bound parts) one at a time through repetition of such an operation.

However, such a technique has posed the following problem. In the case of forming a new layer (upper layer) on the previously formed layer (lower layer) and forming a bound part in the layer (upper layer), if the bound part to be formed on the layer (upper layer) has a region that does not overlap the bound part formed in the lower layer, the ink that has been applied to form the bound part in that region penetrates not only to the upper layer but also to the lower layer, thus making it impossible to form a bound part having an intended shape, and reducing the dimensional accuracy of the resulting final three-dimensional shaped object.

### SUMMARY

An advantage of some aspects of the invention is to provide a three-dimensional shaped object manufacturing method that enables efficient manufacture of a three-dimensional shaped object having excellent dimensional accuracy, and to provide a three-dimensional shaped object having excellent dimensional accuracy.

Such an advantage can be achieved by the following aspects of the invention.

A three-dimensional shaped object manufacturing method according to an aspect of the invention is a three-dimensional shaped object manufacturing method for manufacturing a three-dimensional shaped object by laminating layers, including:

a layer forming step of forming each of the layers by using a layer-forming composition containing particles and a solvent;

a first liquid application step of applying, onto the layer in a state of containing the solvent, a liquid used to form a solidified part; and

a solvent removal step of removing the solvent from the layer.

This makes it possible to provide a three-dimensional shaped object manufacturing method that enables efficient manufacture of a three-dimensional shaped object having excellent dimensional accuracy.

In the three-dimensional shaped object manufacturing method according to an aspect of the invention, it is preferable that at least a portion of the solidified part formed on a surface of an nth layer from below is embedded in an (n+1)th layer from below in the layer forming step performed after the first liquid application step for forming the solidified part (where n is an integer of 1 or more).

This can remarkably improve the dimensional accuracy of the three-dimensional shaped object.

In the three-dimensional shaped object manufacturing method according to an aspect of the invention, it is preferable that, in the first liquid application step, the liquid is applied to a surface of the layer containing the solidified part, in a region containing an area that does not overlap the solidified part when the layer is seen in plan view.

This enables the effects of the invention to be exerted more prominently.

Preferably, the three-dimensional shaped object manufacturing method according to an aspect of the invention further includes, after the solvent removal step, a second liquid application step of applying a liquid that is used to form a solidified part to the layer in a state in which the solvent has been removed therefrom, so as to allow the liquid to penetrate into the layer.

This enables the solidified part to be formed inside the layer, thus making it possible for the resulting final three-dimensional shaped object to have particularly high mechanical strength, be more reliably prevented from undesired deformation, and hence be highly reliable.

Preferably, the three-dimensional shaped object manufacturing method according to an aspect of the invention further includes a third liquid application step of applying, onto a stage on which the layer is not formed, a liquid that is used to form a solidified part.

This can remarkably improve the productivity of the three-dimensional shaped object. In addition, this can remarkably improve the aesthetic appearance of the three-dimensional shaped object as a whole.

In the three-dimensional shaped object manufacturing method according to an aspect of the invention, it is preferable that the layer-forming composition contains an aqueous solvent as the solvent.

This can remarkably improve the fluidity of the layer-forming composition and the uniformity of the composition of the layer formed by using the layer-forming composition. In addition, water can be easily removed after the formation of the layer, and is less likely to cause an adverse effect even when it remains in the three-dimensional shaped object. Furthermore, water is also advantageous in terms of the safety for the human body and environmental issues, for example.

In the three-dimensional shaped object manufacturing method according to an aspect of the invention, it is preferable that the layer-forming composition contains a binder, in addition to the particles and the solvent.

This allows the plurality of particles to be suitably bound (fixed temporarily) in the layer formed by using the layer-forming composition, thus effectively preventing undesired scattering or the like of the particles. Thereby, it is possible to further improve the safety for the operator and the dimensional accuracy of the manufactured three-dimensional shaped object.

In the three-dimensional shaped object manufacturing method according to an aspect of the invention, it is preferable that the liquid contains a curable resin.

This can remarkably improve the mechanical strength of the resulting three-dimensional shaped object and the productivity and the like of the three-dimensional shaped object. In addition, this can remarkably improve the dimensional accuracy and the reliability of the three-dimensional shaped object.

In the three-dimensional shaped object manufacturing method according to an aspect of the invention, it is preferable that the liquid contains an acrylic polymerizable compound.

This can remarkably improve the strength of the resulting final three-dimensional shaped object.

In the three-dimensional shaped object manufacturing method according to an aspect of the invention, it is preferable that the liquid contains a silicone-based polymerizable compound.

This makes it possible to suitably manufacture a three-dimensional shaped object constituted, for example, by a material having elasticity like rubber.

A three-dimensional shaped object according to an aspect of the invention is manufactured by using the three-dimensional shaped object manufacturing method according to an aspect of the invention.

This makes it possible to provide a three-dimensional shaped object having excellent dimensional accuracy.

### BRIEF DESCRIPTION OF THE DRAWINGS

FIGS. 1A to 1E are cross-sectional views schematically showing steps of a three-dimensional shaped object manufacturing method according to a preferred embodiment of the invention.

FIGS. 2A to 2D are cross-sectional views schematically showing steps of the three-dimensional shaped object manufacturing method according to a preferred embodiment of the invention.

FIGS. 3A to 3C are cross-sectional views schematically showing steps of the three-dimensional shaped object manufacturing method according to a preferred embodiment of the invention.

### DESCRIPTION OF EXEMPLARY EMBODIMENTS

The following is a detailed description of a preferred embodiment of the invention with reference to the accompanying drawings.

Three-Dimensional Shaped Object Manufacturing Method

First, a description will be given of a three-dimensional shaped object manufacturing method according to the invention.

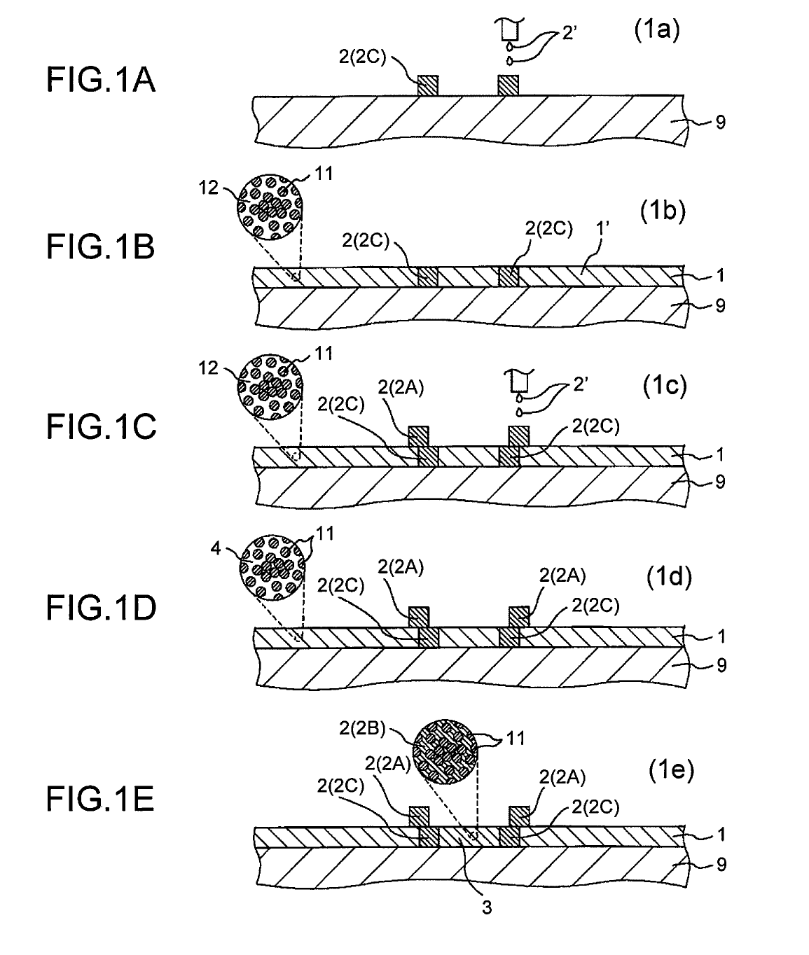

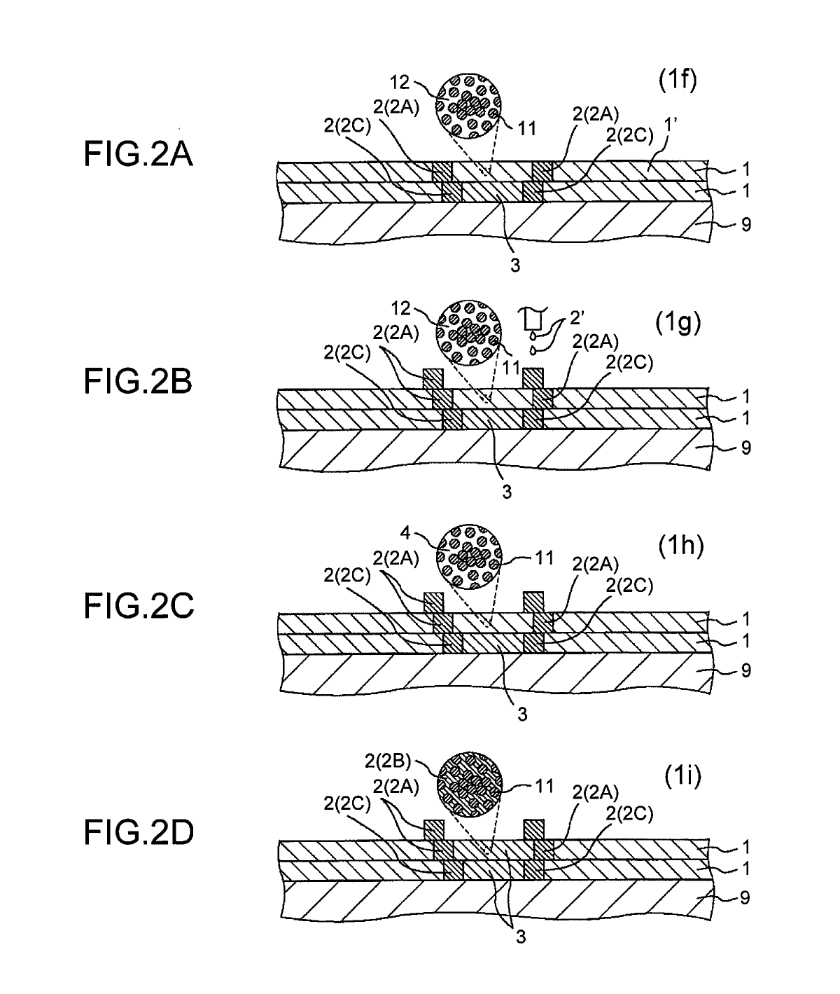

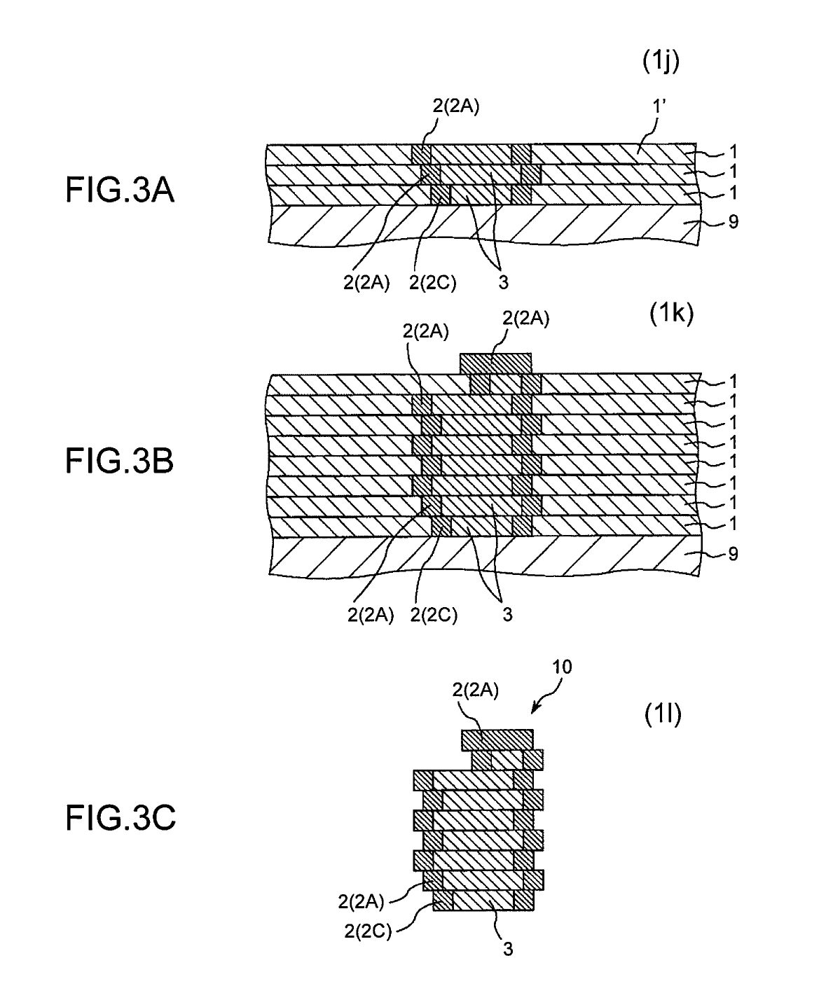

FIGS. 1A-1E, 2A-2D and 3A-3C are cross-sectional views schematically showing steps of a three-dimensional shaped object manufacturing method according to a preferred embodiment of the invention.

As shown in FIGS. 1A-1E, 2A-2D and 3A-3C, a manufacturing method of a three-dimensional shaped object 10 according to the present embodiment includes a layer forming step (1b, 1f, 1j) of forming a layer 1 by using a layer-forming composition 1′ containing particles 11 and a solvent 12, a first liquid application step (1c, 1g) of applying, onto the layer 1 in a state of containing the solvent 12, a liquid (solidified-part-forming liquid) 2′ used to form a solidified part 2 (first solidified part 2A), a solvent removal step (1d, 1h) of removing the solvent 12 from the layer 1, and a second liquid application step (1e, 1i) of applying, onto the layer 1 in a state in which the solvent 12 has been removed therefrom, a liquid (solidified-part-forming liquid) 2′ used to form a solidified part 2 (second solidified part 2B), so as to allow the liquid 2′ to penetrate into the above-referenced layer 1. The method includes, after sequentially repeating these steps (1k), an unbound particle removal step (1l) of removing those of the particles 11 constituting each layer 1 that are not bound in the solidified part 2.

By applying the liquid (solidified-part-forming liquid) 2′ used to form the solidified part 2 (first solidified part 2A) onto the layer 1 in the state of containing the solvent 12 in the first liquid application step in this way, it is possible to prevent undesirable penetration of the liquid 2′ used to form the solidified part 2 into an area other than the intended area. Consequently, a solidified part 2 (first solidified part 2A) having the desired shape can be formed in a simple and reliable manner, as a result of which it is possible to efficiently manufacture a three-dimensional shaped object 10 having excellent dimensional accuracy.

Further, according to the present embodiment, the method further includes, prior to the first layer forming step, a third liquid application step (1a) of applying, onto a stage 9 on which the layer 1 (layer 1 formed by using the layer-forming composition 1′) is not formed, a liquid (solidified-part-forming liquid) 2′ used to form a solidified part 2 (third solidified part 2C).

This makes it possible to form a solidified part 2 embedded in the layer 1 located on the lowermost side (solidified part 2 free of the particles 11) and eliminate the need to form a layer 1 that does not contain a solidified part 2 free of the particles 11, thus remarkably improving the productivity of the three-dimensional shaped object 10. Further, in the resulting final three-dimensional shaped object 10, the solidified parts 2 that constitute the outer surface when seen in side view can be entirely constituted by areas formed of the material free of the particles 11, and it is therefore possible to remarkably improve the aesthetic appearance of the three-dimensional shaped object 10 as a whole.

The following is a description of each of the steps.

Third Liquid Application Step

In the third liquid application step, the liquid 2′ used to form the solidified part 2 (third solidified part 2C) is applied by an ink jet method onto the stage 9 on which the layer 1 is not formed (see 1a).

In the present step, the liquid 2′ is applied to an area corresponding to a portion of the resulting final three-dimensional shaped object 10. In the configuration shown, the liquid 2′ is applied to an area corresponding to a region near the outer surface that can be seen when the resulting final three-dimensional shaped object 10 is seen in side view.

Thereby, for example, the solidified parts 2 that constitute the outer surface when seen in side view can be entirely constituted by areas formed of the material free of the particles 11 in the resulting final three-dimensional shaped object 10, and it is therefore possible to remarkably improve the aesthetic appearance of the three-dimensional shaped object 10 as a whole.

In particular, since the liquid 2′ is applied by an ink jet method in the present step, the liquid 2′ can be applied with good reproducibility even if the liquid 2′ is applied in a fine pattern. Consequently, the dimensional accuracy of the resulting final three-dimensional shaped object 10 can be remarkably increased.

As the liquid 2′, any liquid can be used as long as it contains the constituent of the solidified part 2 (third solidified part 2C). For example, it is possible to use a liquid obtained by dissolving a resin material in a solvent, a liquid containing a molten resin material, and a liquid containing a polymerizable compound (uncured resin material).

The applied liquid 2′ is subjected to a subsequent predetermined treatment, thus forming a solidified part 2 (third solidified part 2C) (the same applies to the liquid 2′ applied in the first liquid application step and the liquid 2′ applied in the second liquid application step, which will be described later).

For example, when a liquid obtained by dissolving a resin material in a solvent is used as the liquid 2′, the solidified part 2 is formed by removing the solvent after application of the liquid 2′.

When a molten resin material is used as the liquid 2′, the solidified part 2 is formed by performing cooling after application of the liquid 2′.

When a liquid containing a polymerizable compound (uncured resin material) is used as the liquid 2′, the solidified part 2 in the form of a cured part is formed by curing the polymerizable compound after application of the liquid 2′. The method of curing the polymerizable compound varies depending on the type of polymerizable compound. For example, when the polymerizable compound is a thermosetting polymerizable compound (thermosetting resin), the compound can be cured by heating. When the polymerizable compound is a photo-curable polymerizable compound (photo-curable resin), the compound can be cured by irradiation of light.

To form a solidified part 2 having a predetermined thickness within a single step, a series of treatments including the application of the liquid 2′ and the solidification of the liquid 2′ may be repeated.

Note that the detailed description of the liquid 2′ will be given later.

Layer Forming Step

In the layer forming step, a layer 1 having a predetermined thickness is formed by using the composition (layer-forming composition) 1′ containing the particles 11 and the solvent 12 (see 1b, 1f, 1j).

In particular, the first layer forming step forms, on the stage (support) 9 on which the solidified part 2 (third solidified part 2C) is provided, a layer 1 having a predetermined thickness by using the composition (layer-forming composition) 1′ containing the particles 11 and the solvent 12 (1b). Then, the second and onward layer forming steps form, on the layer 1 (in the configuration shown, the layer 1 in which a bound part 3 is formed), a new layer 1 having a predetermined thickness by using the composition (layer-forming composition) 1′ containing the particles 11 and the solvent 12 (1f, 1j).

Note that the detailed description of the composition (layer-forming composition) 1′ will be given later.

In the present step, the layer 1 is formed so as to have a planarized surface by using a planarizer such as a squeegee or a roller.

According to the present embodiment, at least a portion of the previously formed solidified part 2 is embedded into the layer 1 that is formed in the present step.

That is, in the layer forming step that is performed in a state in which the solidified part 2 (third solidified part 2C) formed in the above-described third liquid application step is exposed to the outer surface, at least a portion of the solidified part 2 (third solidified part 2C) is embedded (see 1b). In the layer forming step that is performed in a state in which the solidified part 2 (first solidified part 2A) formed in the first liquid application step described below is exposed to the outer surface, at least a portion of the solidified part 2 (first solidified part 2A) is embedded (see 1f, 1j).

Thereby, for example, the shape stability of a solidified part 2 that is formed in a subsequent step on the upper surface side of the aforementioned solidified part 2 (solidified part 2 that is embedded in the layer 1 in the present step) is improved. As a result, the dimensional accuracy of the three-dimensional shaped object 10 is remarkably improved.

For example, in the case of forming, in a subsequent step, a second solidified part 2B in the layer 1 in which the aforementioned solidified part 2 (solidified part 2 that is embedded in the layer 1 in the present step) is embedded in an area of the layer 1 that comes into contact with the solidified part 2 (see 1e, 1i), it is possible to more effectively prevent any undesired height difference between the solidified part 2 that is embedded in the layer 1 in the present step and the second solidified part 2B. As a result, the dimensional accuracy of the three-dimensional shaped object 10 is remarkably improved.

It is preferable that the present step is performed such that the composition 1′ (especially, the particles 11) will not remain on the upper surface of the solidified part 2 that is embedded in the present step.

This makes it possible to prevent a reduction in the adhesion between the solidified part 2 and a solidified part 2 (first solidified part 2A) that is formed in a subsequent first liquid application step. It is also possible to prevent the aesthetic appearance from being impaired.

In the configuration shown, the thickness of the layer 1 that is formed in the present step is the same as the thickness of the embedded solidified part 2 (third solidified part 2C, first solidified part 2A). However, the thickness of the layer 1 formed in the present step may be smaller than the thickness of the embedded solidified part 2 (third solidified part 2C, first solidified part 2A). In the case of adopting such a configuration, for example, the pressing performed by the planarizer may be adjusted such that the outer surface of the layer 1 formed in the present step is located at a position lower than the top part of the embedded solidified part 2 (third solidified part 2C, first solidified part 2A). This enables a relatively large pressing force to be applied by the planarizer to the upper surface of the solidified part 2 that is embedded in the present step, making it possible to effectively prevent the composition 1′ (especially, the particles 11) from remaining on the upper surface of the solidified part 2 that is embedded in the present step.

The thickness of the layer 1 formed in the present step is not particularly limited, but is preferably 20 μm or more and 500 μm or less, more preferably 30 μm or more and 150 μm or less, for example.

This can achieve a sufficiently good productivity of the three-dimensional shaped object 10, and more effectively prevent the formation of undesired irregularities or the like in the manufactured three-dimensional shaped object 10, thus remarkably improving the dimensional accuracy of the three-dimensional shaped object 10.

The viscosity of the layer-forming composition in the layer forming step is preferably 500 mPa·s or more and 1000000 mPa·s or less.

This allows the present step to be efficiently performed, thus remarkably improving the productivity of the three-dimensional shaped object 10. As used herein, the viscosity refers to a value measured at 25° C. by using an E-type viscometer (VISCONIC ELD manufactured by TOKYO KEIKI INC.).

First Liquid Application Step

In the first liquid application step, the liquid 2′ used to form the solidified part 2 (first solidified part 2A) is applied to a region including the surface (upper surface) of the layer 1, formed in the layer forming step, in the state of containing the solvent 12 (see 1c, 1g).

As a result of the layer 1 to which the liquid 2′ is applied being in the state of containing the solvent 12, or in other words, in the state in which the gaps between the particles 11 in the layer 1 are filled with the solvent, during application of the liquid 2′, it is possible to suitably prevent undesired penetration of the liquid 2′ into the layer 1, thus forming the solidified part 2 (first solidified part 2A) with the desired shape on the upper surface of the layer 1.

In particular, the present embodiment includes the first liquid application step of applying the liquid 2′ to the surface of the layer 1 including the embedded solidified part 2 (first solidified part 2A, third solidified part 2C), in a region including an area that does not overlap the solidified part 2 (first solidified part 2A, third solidified part 2C) when the layer 1 is seen in plan view (see 1c, 1g).

Three-dimensional shaping methods in the related art often suffer from the following problem: in the case of forming a new layer (upper layer) on the surface of a layer (lower layer) that has been already formed and then forming a bound part (solidified part) on the layer (upper layer), if the bound part (solidified part) that is to be formed on the layer (upper layer) includes a region that does not overlap the bound part (solidified part) formed on the lower layer, a bound part (solidified part) with an intended shape cannot be formed, leading to a reduction in the dimensional accuracy of the resulting final three-dimensional shaped object. However, according to the invention, even in the case of manufacturing a three-dimensional shaped object having such a configuration, it is possible to remarkably improve the dimensional accuracy of the resulting final three-dimensional shaped object. Accordingly, the effects of the invention can be more prominently exerted when the method includes the first liquid application step of applying a liquid to the surface of a layer including an embedded solidified part (first solidified part, third solidified part), in a region including an area that does not overlap the solidified part (first solidified part, third solidified part) when the layer is seen in plan view.

In contrast, when a liquid is applied to an area of a layer in which no solidified part is provided in the state in which the layer does not contain the solvent, it is difficult to retain the liquid on the surface of the layer, and the applied liquid penetrates into the layer. Consequently, it becomes difficult to form a solidified part with the desired shape by using the liquid, resulting in a reduced dimensional accuracy of the manufactured three-dimensional shaped object.

Since the liquid 2′ is applied by an ink jet method in the present step, the liquid 2′ can be applied with good reproducibility even if the liquid 2′ is applied in a fine pattern. Consequently, the dimensional accuracy of the resulting final three-dimensional shaped object 10 can be remarkably increased.

Solvent Removal Step

In the solvent removal step, the solvent 12 is removed from the layer 1 (see 1d, 1h).

Thereby, a space 4 where a solvent or the like is not present is formed between the particles constituting the layer 1. The space 4 functions as an absorption part that absorbs the liquid 2′ in a subsequent second liquid application step.

Although the present step may be performed under any conditions as long as the solvent 12 can be removed from the layer 1, it may be performed, for example, by heat treatment, decompression treatment, air blowing or the like.

When the present step is performed by heating, the heating temperature is, for example, preferably 30° C. or more and 100° C. or less, more preferably 60° C. or more and 95° C. or less, although this may vary depending on the materials and the like (e.g., the type of particles 11 and solvent 12) constituting the layer 1. To prevent a shape change due to a rapid vaporization, the upper limit of the temperature is preferably less than or equal to the boiling point of the solvent 12.

This makes it possible to efficiently remove the solvent 12, while preventing undesired degeneration of the material and the like constituting the layer 1 and undesired deformation of the layer 1 and the like, thus remarkably improving the productivity of the three-dimensional shaped object 10.

Second Liquid Application Step

In the second liquid application step, the liquid 2′ used to form a solidified part 2 (second solidified part 2B) is applied to a layer 1 in a state in which the solvent 12 has been removed therefrom, so as to allow the liquid 2′ to penetrate into the layer 1 (see 1e, 1i).

Thereby, the solidified part 2 (second solidified part 2B) can be formed inside the layer 1 (area that constituted the space 4 between the particles 11), as a result of which a bound part 3 in which the particles 11 are bound can be formed by the solidified part 2 (second solidified part 2B). The thus formed bound part 3 contains the particles 11 and the solidified part 2 (second solidified part 2B), and thus has remarkably improved hardness and mechanical strength. Accordingly, the resulting final three-dimensional shaped object 10 has excellent mechanical strength, is more reliably prevented from being undesirably deformed, and thus is highly reliable.

Since the liquid 2′ is applied by an ink jet method in the present step, the liquid 2′ can be applied with good reproducibility even if the liquid 2′ is applied in a fine pattern. Consequently, the dimensional accuracy of the resulting final three-dimensional shaped object 10 can be remarkably increased.

Unbound Particle Removal Step

After the above-described series of steps are repeated (see 1k), the unbound particle removal step of removing those (unbound particles) of the particles 11 constituting each layer 1 that are not bound by the solidified part 2 is performed as an aftertreatment step (see 1l). Thereby, the three-dimensional shaped object 10 is collected.

Examples of the specific methods for the present step include a method of brushing away unbound particles with a brush or the like, a method of removing unbound particles by suction, a method of spraying a gas such as air, a method of applying a liquid such as water (e.g., a method of immersing a laminate obtained in the above-described manner into a liquid, a method of spraying a liquid), and a method of applying vibrations such as ultrasonic vibrations. Two or more methods selected from these may be performed in combination. More specific examples include a method of immersing unbound particles in a liquid such as water after spraying a gas such as air, and a method of applying ultrasonic vibrations to unbound particles in a state of being immersed in a liquid such as water. In particular, it is preferable to adopt a method of applying a liquid containing water to a laminate obtained in the above-described manner (especially, a method of immersing the laminate in a liquid containing water).

With the above-described manufacturing method according to the invention, a three-dimensional shaped object having excellent dimensional accuracy and excellent mechanical strength and durability can be manufactured efficiently. Furthermore, the yield of the three-dimensional shaped objects is improved, which is also advantageous in terms of the reduction in the manufacturing cost of the three-dimensional shaped object.

Liquid (Solidified-Part-Forming Liquid)

Next is a detailed description of a liquid (solidified-part-forming liquid) used to manufacture the three-dimensional shaped object according to the invention.

The liquid (solidified-part-forming liquid) 2′ contains at least the constituent (including a precursor) of the solidified part 2.

Resin Material

Preferably, the liquid 2′ contains a resin material.

This can remarkably improve the strength and the like of the formed solidified part 2. Further, the liquid 2′ can suitably function as a binding agent for binding the particles 11 in the second solidified part 2B, making it possible to remarkably improve the mechanical strength and the shape stability of the three-dimensional shaped object 10.

Examples of the resin material include thermoplastic resins; thermosetting resins; various photo-curable resins such as visible light curable resins (photo-curable resin in the narrower sense) that are cured by light in the visible light range, an ultraviolet curable resin and an infrared curable resin; and X-ray curable resins. These may be used alone or in combination of two or more.

In particular, the resin material contained in the liquid 2′ is preferably a curable resin.

This can remarkably improve the mechanical strength of the resulting three-dimensional shaped object 10 and the productivity and the like of the three-dimensional shaped object 10. When the curable resin is used, the heat resistance of the cured part as the solidified part 2 is generally excellent. Accordingly, undesired deformation and undesired degeneration or deterioration of the materials can be more effectively prevented in the solidified part 2 that experiences a cumulative thermal history due to lamination, making it possible to remarkably improve the dimensional accuracy and the reliability of the three-dimensional shaped object 10.

Among various curable resins, an ultraviolet curable resin (polymerizable compound) is particularly preferable in terms of the mechanical strength of the resulting three-dimensional shaped object 10 and the productivity of the three-dimensional shaped object 10, the storage stability of the liquid 2′, and the like.

As the ultraviolet curable resin (polymerizable compound), it is preferable to use a compound for which addition polymerization or ring-opening polymerization can be initiated by radical species or cation species produced from a photo-polymerization initiator by ultraviolet irradiation, thus producing a polymer. The polymerization modes of the addition polymerization include radical, cationic, anionic, metathesis, and coordination polymerizations. The polymerization modes of the ring-opening polymerization include cationic, anionic, radical, metathesis, and coordination polymerizations.

Examples of the addition-polymerizable compound include a compound or the like having at least one ethylenically unsaturated double bond. As the addition-polymerizable compound, it is preferable to use a compound having at least one, preferably two or more, terminal ethylenically unsaturated bonds.

The ethylenically unsaturated polymerizable compound has the chemical forms of a monofunctional polymerizable compound and a polyfunctional polymerizable compound, or the chemical form of a mixture thereof. Examples of the monofunctional polymerizable compound include unsaturated carboxylic acid (e.g., acrylic acid, methacrylic acid, itaconic acid, crotonic acid, isocrotonic acid, and maleic acid), and esters and amides thereof. As the polyfunctional polymerizable compound, it is possible to use esters of unsaturated carboxylic acid and an aliphatic polyhydric alcohol compound, and amides of unsaturated carboxylic acid and an aliphatic polyvalent amine compound.

In particular, it is preferable that the liquid 2′ contains, as the polymerizable compound, an acrylic polymerizable compound such as acrylic acid, methacrylic acid, or a derivative thereof (e.g., an ester compound).

This can remarkably improve the strength of the resulting final three-dimensional shaped object 10.

It is also possible to use, for example, addition reaction products of unsaturated carboxylic acid esters or amides having a nucleophilic substituent such as a hydroxyl group, an amino group or a mercapto group with isocyanates or epoxies, and dehydration condensation reaction products with carboxylic acid. It is also possible to use addition reaction products of unsaturated carboxylic acid esters or amides having an electrophilic substituent such as an isocyanate group or an epoxy group with alcohols, amines and thiols, and substitution reaction products of unsaturated carboxylic acid esters or amides having a leaving substituent such as a halogen group or a tosyloxy group with alcohols, amines or thiols.

A typical example of a radically polymerizable compound, which is an ester of unsaturated carboxylic acid and an aliphatic polyhydric alcohol compound, is (meth)acrylic acid ester, and both monofunctional and polyfunctional (meth)acrylic acid esters can be used.

Specific examples of monofunctional (meth)acrylate include tolyloxyethyl(meth)acrylate, phenyloxyethyl(meth)acrylate, cyclohexyl(meth)acrylate, ethyl(meth)acrylate, methyl(meth)acrylate, isobornyl(meth)acrylate, and tetrahydrofurfuryl(meth)acrylate.

Specific examples of bifunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Specific examples of trifunctional (meth)acrylate include trimethylolpropane tri(meth)acrylate, trimethylolethane tri(meth)acrylate, alkyleneoxide-modified tri(meth)acrylate of trimethylolpropane, pentaerythritol tri(meth)acrylate, dipentaerythritol tri(meth)acrylate, trimethylolpropane tri((meth)acryloyloxypropyl)ether, isocyanuric acid alkyleneoxide-modified tri(meth)acrylate, propionic acid dipentaerythritol tri(meth)acrylate, tri((meth)acryloyloxyethyl)isocyanurate, hydroxypivalaldehyde-modified dimethylolpropane tri(meth)acrylate, and sorbitol tri(meth)acrylate.

Specific examples of tetrafunctional (meth)acrylate include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Examples of pentafunctional (meth)acrylate include sorbitol penta(meth)acrylate and dipentaerythritol penta(meth)acrylate.

Specific examples of hexafunctional (meth)acrylate include dipentaerythritol hexa(meth)acrylate, sorbitol hexa(meth)acrylate, alkyleneoxide-modified hexa(meth)acrylate of phosphazene, and caprolactone-modified dipentaerythritol hexa(meth)acrylate.

Examples of polymerizable compounds other than (meth)acrylate include itaconic acid esters, crotonic acid esters, isocrotonic acid esters, and maleic acid esters.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycoldiisocrotonate, pentaerythritol diisocrotonate, and sorbitol tetraisocrotonate.

Examples of maleic acid esters include ethylene glycol dimalate, triethylene glycol dimalate, pentaerythritol dimalate, and sorbitol tetramalate.

Specific examples of the monomer of an amide of unsaturated carboxylic acid and an aliphatic polyvalent compound include methylene bis-acrylamide, methylene bis-methacrylamide, 1,6-hexamethylene bis-acrylamide, 1,6-hexamethylene bis-methacrylamide, diethylenetriaminetrisacrylamide, xylylenebisacrylamide, and xylylenebismethacrylamide.

A urethane-based addition-polymerizable compound, which can be produced by using addition reaction between isocyanate and a hydroxyl group, is also preferred. Specific examples thereof include a vinyl urethane compound having two or more polymerizable vinyl groups in one molecule, which is obtained by adding a vinyl monomer containing a hydroxyl group represented by Formula (1) below to a polyisocyanate compound having two or more isocyanate groups in one molecule.

CH2═C(R1)COOCH₂CH(R2)OH (1)

where R1 and R2 each independently represent H or

CH3.

According to the invention, a cationic ring-opening polymerizable compound having one or more cyclic ether groups such as an epoxy group or an oxetane group in one molecule can be preferably used as the ultraviolet curable resin (polymerizable compound).

Examples of the cationic polymerizable compound include curable compounds containing a ring-opening polymerizable group. Among them, a curable compound containing a heterocyclic group is particularly preferable. Examples of such a curable compound include epoxy derivatives, oxetane derivatives, tetrahydrofuran derivatives, cyclic lactone derivatives, cyclic carbonate derivatives, cyclic imino ethers such as oxazoline derivatives, and vinyl ethers. Among them, epoxy derivatives, oxetane derivatives, and vinyl ethers are preferable.

Examples of preferable epoxy derivatives include monofunctional glycidyl ethers, polyfunctional glycidyl ethers, monofunctional alicyclic epoxies, and polyfunctional alicyclic epoxies.

Examples of specific compounds of glycidyl ethers include diglycidyl ethers (e.g., ethylene glycol diglycidyl ether and bisphenol A diglycidyl ether), trifunctional or higher functional glycidyl ethers (e.g., trimethylol ethane triglycidyl ether, trimethylol propane triglycidyl ether, glycerol triglycidyl ether, and triglycidyl tris hydroxyethyl isocyanurate), tetrafunctional or higher functional glycidyl ethers (e.g., sorbitol tetraglycidyl ether, pentaerythritol tetraglycidyl ether, polyglycidyl ether of cresol novolac resin, and polyglycidyl ether of phenol novolac resin), alicyclic epoxies (e.g., polycyclohexyl epoxy methyl ether of phenol novolac resin), and oxetanes.

As the polymerizable compound, an alicyclic epoxy derivative can be preferably used. “Alicyclic epoxy group” refers to a partial structure in which a double bond of a cycloalkene ring such as a cyclopentene group or a cyclohexene is epoxidized with a suitable oxidizing agent such as hydrogen peroxide or peracid.

As the alicyclic epoxy compound, polyfunctional alicyclic epoxies having two or more cyclohexene oxide groups or cyclopentene oxide groups in one molecule are preferable. Specific examples of the alicyclic epoxy compound include 4-vinylcyclohexene dioxide, (3,4-epoxycyclohexyl)methyl-3,4-epoxycyclohexyl carboxylate, di(3,4-epoxycyclohexyl)adipate, di(3,4-epoxycyclohexylmethyl)adipate, bis(2,3-epoxycyclopentyl)ether, di(2,3-epoxy-6-methylcyclohexylmethyl)adipate, and dicyclopentadiene dioxide.

It is also possible to use a glycidyl compound having a normal epoxy group having no alicyclic structure in its molecule, either alone or in combination with the above-described alicyclic epoxy compounds.

Examples of such normal glycidyl compounds include a glycidyl ether compound and a glycidyl ester compound, and it is preferable to use a glycidyl ether compound in combination.

Specific examples of the glycidyl ether compound include aromatic glycidyl ether compounds such as 1,3-bis(2,3-epoxypropyloxy)benzene, bisphenol A-type epoxy resin, bisphenol F-type epoxy resin, phenol novolac-type epoxy resin, cresol novolac-type epoxy resin and trisphenol methane-type epoxy resin, and aliphatic glycidyl ether compounds such as 1,4-butanediol glycidyl ether, glycerol triglycidyl ether, propylene glycol diglycidyl ether, and trimethylolpropane triglycidyl ether. Examples of the glycidyl ester include a glycidyl ester of a linolenic acid dimer.

As the polymerizable compound, it is possible to use a compound having an oxetanyl group, which is a 4-membered ring cyclic ether, (hereinafter also simply referred to as “oxetane compound”). An oxetanyl group-containing compound is a compound having one or more oxetanyl groups in one molecule.

The liquid 2′ may contain, as the polymerizable compound, a silicone-based polymerizable compound (compound that forms a silicone-based resin by polymerization).

This makes it possible to suitably manufacture a three-dimensional shaped object 10 formed of a material having elasticity like rubber, for example. As a result, it is possible to suitably manufacture a three-dimensional shaped object having parts capable of moving or changing its shape by elastic deformation.

The resin material content in the liquid 2′ is preferably 80 mass % or more, more preferably 85 mass % or more. This can remarkably improve the mechanical strength and the like of the resulting final three-dimensional shaped object 10.

Other Components

The liquid 2′ may also contain components other than those described above. Examples of such components include various colorants such as a pigment and a dye; a dispersing agent; a surfactant; a polymerization initiator; a polymerization accelerator; a solvent; a penetration enhancer; a humectant (moisturizer); a fixing agent; an antifungal agent; an antiseptic agent; an antioxidant; an ultraviolet absorber; a chelating agent; a pH controlling agent; a thickener; a filler; an anti-agglomeration agent; and an antifoaming agent.

In particular, when the liquid 2′ contains a colorant, it is possible to obtain a three-dimensional shaped object 10 colored with a color corresponding to the color of the colorant.

In particular, when the liquid 2′ contains a pigment as the colorant, it is possible to achieve a favorable light resistance of the liquid 2′ and the three-dimensional shaped object 10. As the pigment, both an inorganic pigment and an organic pigment are usable.

Examples of the inorganic pigment include carbon blacks (C.I. pigment blacks) such as furnace black, lamp black, acetylene black and channel black, iron oxide, and titanium oxide. One or, a combination of two or more selected from these may be used.

Among the inorganic pigments, titanium oxide is preferably used in order to present a preferable white color.

Examples of the organic pigment include azo pigments such as an insoluble azo pigment, a condensed azo pigment, azo lake and chelate azo pigments, phthalocyanine pigments, polycyclic pigments such as perylene and perinone pigments, an anthraquinone pigment, a quinacridone pigment, a dioxane pigment, a thioindigo pigment, an isoindoline pigment and a quinophthalone pigment, dye chelate (e.g., basic dye-type chelate, acid dye-type chelate), dye lake (basic dye-type lake, acid dye-type lake), nitro pigments, nitroso pigments, aniline black, and daylight fluorescent pigments. These may be used alone or in combination of two or more.

When the liquid 2′ contains a pigment, the average particle diameter of the pigment is preferably 300 nm or less, more preferably 50 nm or more and 250 nm or less. This can remarkably improve the jetting stability of the liquid 2′ and the dispersion stability of the pigment in the liquid 2′, and form an image with improved image quality.

As used herein, the average particle diameter refers to an average particle diameter on a volume basis, and can be obtained, for example, by measuring a dispersion liquid, obtained by adding a sample to methanol and dispersing the sample for three minutes by an ultrasonic disperser, by using a 50 μm aperture with a particle size distribution measuring instrument based on the Coulter counter method (a TA-II model manufactured by COULTER ELECTRONICS INC.).

Examples of the dye include acid dyes, direct dyes, reactive dyes, and basic dyes. These may be used alone or in combination of two or more.

When the liquid 2′ contains a colorant, the colorant content in the liquid 2′ is preferably 1 mass % or more and 20 mass % or less. This can provide particularly excellent concealability and color reproducibility.

In particular, when the liquid 2′ contains titanium oxide as the colorant, the titanium oxide content in the liquid 2′ is preferably 12 mass % or more and 18 mass % or less, more preferably 14 mass % or more and 16 mass % or less. This can provide particularly excellent concealability.

When the liquid 2′ containing a pigment further contains a dispersing agent, it is possible to achieve better dispersibility of the pigment. Examples of the dispersing agent include, but are not particularly limited to, a dispersing agent such as a polymer dispersing agent, which is commonly used to prepare a pigment dispersion liquid. Specific examples of the polymer dispersing agent include a dispersing agent composed mainly of at least one of polyoxyalkylene polyalkylene polyamine, vinyl-based polymers and copolymers, acrylic polymers and copolymers, polyester, polyamide, polyimide, polyurethane, amino-based polymers, silicon-containing polymers, sulfur-containing polymers, fluorine-containing polymers, and epoxy resin.

When the liquid 2′ contains a surfactant, it is possible to achieve better scrub resistance of the three-dimensional shaped object 10. Usable examples of the surfactant include, but are not limited to, polyester-modified silicone and polyether-modified silicone as silicone-based surfactants. Among these, it is preferable to use polyether-modified polydimethylsiloxane or polyester-modified polydimethylsiloxane.

The liquid 2′ may contain a solvent. This enables the viscosity of the liquid 2′ to be adjusted suitably, making it possible to remarkably improve the jetting stability of the liquid 2′ by an ink jet method even for a liquid 2′ containing a high-viscosity component.

Examples of the solvent include (poly)alkylene glycol monoalkyl ethers such as ethylene glycol monomethyl ether, ethylene glycol monoethyl ether, propylene glycol monomethyl ether and propylene glycol monoethyl ether; acetic acid esters such as ethyl acetate, n-propyl acetate, iso-propyl acetate, n-butyl acetate and iso-butyl acetate; aromatic hydrocarbons such as benzene, toluene and xylene; ketones such as methyl ethyl ketone, acetone, methyl isobutyl ketone, ethyl-n-butyl ketone, diisopropyl ketone and acetyl acetone; and alcohols such as ethanol, propanol and butanol. These may be used alone or in combination of two or more.

The viscosity of the liquid 2′ is preferably 2 mPa·s or more and 30 mPa·s or less, more preferably 5 mPa·s or more and 20 mPa·s or less. This can remarkably improve the jetting stability of the liquid 2′ by an ink jet method.

A plurality of types of liquids 2′ may be used to manufacture the three-dimensional shaped object 10.

For example, the liquid 2′ used in the first liquid application step (liquid 2′ used to form the first solidified part 2A), the liquid 2′ used in the second liquid application step (liquid 2′ used to form the second solidified part 2B), and the liquid 2′ used in the third liquid application step (liquid 2′ used to form the third solidified part 2C) may be identical to or different from each other.

A liquid 2′ containing a colorant (color ink) and a liquid 2′ free of a colorant (clear ink) may be used. Accordingly, for example, the liquid 2′ containing a colorant may be used as the liquid 2′ applied to a region that affects the color tone in the appearance of the three-dimensional shaped object 10, and the liquid 2′ free of a colorant may be used as the liquid 2′ applied to a region that does not affect the color tone in the appearance of the three-dimensional shaped object 10. A plurality of types of liquids 2′ may be used in combination such that a region formed by the liquid 2′ free of a colorant (coat layer) is provided on the outer surface of a region formed by using the liquid 2′ containing a colorant in the resulting final three-dimensional shaped object 10.

It is also possible to use a plurality of types of liquids 2′ containing colorants having different compositions, for example. Thereby, combinations of these liquids 2′ can expand the representable color reproduction range.

When a plurality of types of liquids 2′ are used, it is preferable to use at least a cyan liquid 2′, a magenta liquid 2′, and a yellow liquid 2′. Thereby, combinations of these liquids 2′ can further expand the representable color reproduction range.

Using a white liquid 2′ in combination with a different colored liquid 2′ can provide the following effect, for example. That is, the resulting final three-dimensional shaped object 10 can have a first region to which the white liquid 2′ is applied and a region (second region) to which a colored liquid 2′ other than white is applied and that overlaps the first region and is provided on the outer surface side with respect to the first region. Thereby, the first region to which the white liquid 2′ is applied can exert concealability, making it possible to further increase the saturation of the three-dimensional shaped object 10.

Layer-Forming Composition

Next is a detailed description of a layer-forming composition used to manufacture the three-dimensional shaped object according to the invention.

The composition (layer-forming composition) 1′ contains particles 11 as a filler and a solvent 12 as a dispersing medium for dispersing the particles 11.

The use of such a layer-forming composition 1′ can remarkably improve the mechanical strength and the like of the resulting final three-dimensional shaped object 10, improve the fluidity of the composition 1′, and effectively prevent agglomeration and the like of the particles 11, thus remarkably improving the ease of handling (handleability) of the composition 1′ during manufacture. In addition, as described above, the first solidified part 2A and the second solidified part 2B that have different positional relationships with respect to the layer 1 formed by using the composition 1′ can be separately formed in a simple and reliable manner, thus making it possible to remarkably improve the mechanical strength and the like of the manufactured three-dimensional shaped object 10, and improve the dimensional accuracy.

Particles

The layer-forming composition 1′ contains a plurality of particles 11.

Preferably, the particles 11 have a high degree of hardness.

This can remarkably improve the mechanical strength and the like of the resulting final three-dimensional shaped object 10.

The hardness of the particles 11 can be determined, for example, by a particle compressive strength evaluation using an MCT-210 (manufactured by SHIMADZU CORPORATION).

Preferably, the particles 11 are porous with pores being open to the outside, and has been subjected to a hydrophobizing treatment.

With such a configuration, the resin material or a reaction product thereof (hereinafter also collectively referred to simply as “resin material”) constituting the liquid 2′ is allowed to suitably enter into the pores during manufacture of the three-dimensional shaped object 10 (in the second liquid application step), thereby achieving an anchor effect. Consequently, it is possible to remarkably improve the binding force between the particles 11, as a result of which the mechanical strength of the three-dimensional shaped object 10 as a whole can be remarkably improved. Further, the entry of the resin material constituting the liquid 2′ into the pores of the particles 11 can effectively prevent undesired wetting-out of the liquid 2′. As a result, it is possible to further increase the dimensional accuracy of the resulting final three-dimensional shaped object 10.

Examples of the material constituting the particles 11 include an inorganic material, an organic material, and a composite thereof.

Examples of the inorganic material constituting the particles 11 include various metals and metal compounds. Examples of the metal compounds include various metal oxides such as silica, alumina, titanium oxide, zinc oxide, zirconium oxide, tin oxide, magnesium oxide and potassium titanate; various metal hydroxides such as magnesium hydroxide, aluminum hydroxide and calcium hydroxide; various metal nitrides such as silicon nitride, titanium nitride and aluminum nitride; various metal carbides such as silicon carbide and titanium carbide; various metal sulfides such as zinc sulfide; carbonates of various metals such as calcium carbonate and magnesium carbonate; sulfates of various metals such as calcium sulfate and magnesium sulfate; silicates of various metals such as calcium silicate and magnesium silicate; phosphates of various metals such as calcium phosphate; borates of various metals such as aluminum borate and magnesium borate, and composites thereof.

Examples of the organic material constituting the particles 11 include synthetic resins and naturally-occurring polymers. More specific examples thereof include polyethylene resin; polypropylene; polyethylene oxide; polypropylene oxide and polyethylene imine; polystyrene; polyurethane; polyurea; polyester; silicone resin; aclyl silicone resin; polymers having (meth)acrylic acid ester such as polymethyl methacrylate as a constituent monomer; cross polymers (e.g., ethylene acrylic acid copolymer resin) having (meth)acrylic acid ester such as a methyl methacrylate cross polymer as a constituent monomer; polyamide resins such as nylon 12, nylon 6 and a copolymerized nylon; polyimide; carboxymethyl cellulose; gelatin; starch; chitin; and chitosan.

In particular, the particles 11 is preferably constituted by a metal oxide, and more preferably constituted by silica.

This can remarkably improve the properties, such as mechanical strength and light resistance, of the three-dimensional shaped object.

In particular, when the particles 11 are constituted by silica, the above-described effect can be more prominently exerted. In addition, silica is excellent also in fluidity, and thus can be advantageously used to form a layer having higher uniformity in thickness, and can also be advantageously used to remarkably improve the productivity and the dimensional accuracy of the three-dimensional shaped object.

The particles 11 may have been subjected to a surface treatment such as a hydrophobizing treatment.

The hydrophobizing treatment performed on the particles 11 may be any treatment that can increase the hydrophobicity of the particles (core particles), but is preferably a treatment that introduces a hydrocarbon group.

Thereby, it is possible to further increase the hydrophobicity of the particles 11. In addition, the uniformity in the degree of the hydrophobizing treatment in various areas of each particle 11 and the surface of the particle 11 (in the case of particles having pores open to the outside, this includes the inner surface of the pores) in a simple and reliable manner.

As the compound used for the hydrophobizing treatment, a silane compound containing a silyl group is preferable. Specific examples of the compounds that can be used for the hydrophobizing treatment include hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanatepropyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyltri-n-propoxysilane, methylisopropoxysilane, methyl-n-butyloxysilane, methyltri-sec-butyloxysilane, methyltri-t-butyloxysilane, ethyltrimethoxysilane, ethyltriethoxysilane, ethyltri-n-propoxysilane, ethylisopropoxysilane, ethyl-n-butyloxysilane, ethyltri-sec-butyloxysilane, ethyltri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysilane, 2-[2-(trichlorosilyflethyl]pyridine, 4-[2-(trichlorosilyflethyl]pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, ω-aminoundecyltrimethoxysilane, amyltriethoxysilane, benzooxasilepindimethylester, 5-(bicycloheptenyl)triethoxysilane, bis(2-hydroxyethyl)-3-aminopropyltriethoxysilane, 8-bromooctyltrimethoxysilane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyltrichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopent-3-ene, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenylketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 1,2,3,4,7,7,-hexachloro-6-methyldiethoxysilyl-2-norbornene, 1,2,3,4,7,7,-hexachloro-6-triethoxysilyl-2-norbornene, 3-iodopropyltrimethoxysilane, 3-isocyanatepropyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl{2-(3-trimethoxysilylpropylamino)ethylamino}-3-propionate, 7-octenyltrimethoxysilane, R—N-α-phenethyl-N′-triethoxysilylpropylurea, S—N-α-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-O-menthocarbamate, 3-(triethoxysilylpropyl)-p-nitrobenzamide, 3-(triethoxysilyl)propyl succinic anhydride, N-[5-(trimethoxysilyl)-2-aza-1-oxo-pentyl]caprolactam, 2-(trimethoxysilylethyl)pyridine, N-(trimethoxysilylethyl)benzyl-N,N,N-trimethylammonium chloride, phenylvinyldiethoxysilane, 3-thiocyanatepropyltriethoxysilane, (tridecafluoro-1,1,2,2,-tetrahydrooctyl)triethoxysilane, N-{3-(triethoxysilyl)propyl}phthalamidic acid, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonyl azide, β-trimethoxysilylethyl-2-pyridine, trimethoxysilylpropyldiethylenetriamine, N-(3-trimethoxysilylpropyl)pyrrole, N-trimethoxysilylpropyl-N,N,N-tributylammonium bromide, N-trimethoxysilylpropyl-N,N,N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropyldimethylethoxysilane, 3-cyanopropyltrichlorosilane, and fluorinated alkylsilane. These may be used alone or in combination of two or more.

Among these, it is particularly preferable to use hexamethyldisilazane for the hydrophobizing treatment.

Thereby, it is possible to further increase the hydrophobicity of the particles 11. In addition, the uniformity in the degree of the hydrophobizing treatment in various areas of each particle 11 and the surface of the particle 11 (in the case of particles having pores open to the outside, this includes the inner surface of the pores) in a simple and reliable manner.

When the hydrophobizing treatment using a silane compound is performed in a liquid phase, immersing the particles (core particles) to be subjected to the hydrophobizing treatment in a liquid containing the silane compound enables the desired reaction to proceed suitably, thus forming a chemically adsorbed film of the silane compound.

When the hydrophobizing treatment using a silane compound is performed in a gas phase, exposing the particles (core particles) to be subjected to the hydrophobizing treatment to a vapor of the silane compound enables the desired reaction to proceed suitably, thus forming a chemically adsorbed film of the silane compound.

The average particle diameter of the particles 11 is not particularly limited, but is preferably 1 μm or more and 25 μm or less, more preferably 1 μm or more and 15 μm or less.

This can remarkably improve the mechanical strength of the three-dimensional shaped object 10, and more effectively prevent the formation of undesired irregularities or the like in the manufactured three-dimensional shaped object 10, thus remarkably improving the dimensional accuracy of the three-dimensional shaped object 10. In addition, it is possible to remarkably improve the fluidity of the layer-forming composition 1′, thus remarkably improving the productivity of the three-dimensional shaped object 10.

The Dmax of the particles 11 is preferably 3 μm or more and 40 μm or less, more preferably 5 μm or more and 30 μm or less.

This can remarkably improve the mechanical strength of the three-dimensional shaped object 10, and more effectively prevent the formation of undesired irregularities or the like in the manufactured three-dimensional shaped object 10, thus remarkably improving the dimensional accuracy of the three-dimensional shaped object 10. In addition, it is possible to remarkably improve the fluidity of the layer-forming composition 1′, thus remarkably improving the productivity of the three-dimensional shaped object 10.

The porosity of the particles 11 is preferably 50% or more, more preferably 55% or more and 90% or less.

This can ensure a sufficient space (pores) into which the resin material (binding agent) enters, and improve the mechanical strength of the particles 11 themselves, as a result of which it is possible to remarkably improve the mechanical strength of the three-dimensional shaped object 10 including the bound part 3 formed by the resin material having entered into the pores.

According to the invention, the porosity of the particles 11 refers to the ratio (volume fraction) of the pores existing inside the particles 11 relative to the apparent volume of the particles 11, and the value of the porosity can be expressed by {(ρ0−φ/ρ0}×100 when ρ [g/cm³] represents the density of the particles 11 and ρ0 [g/cm³] represents the true density of the material constituting the particles 11.

The average pore size (micropore diameter) of the particles 11 is preferably 10 nm or more, more preferably 50 nm or more and 300 nm or less.

This can remarkably improve the mechanical strength of the resulting final three-dimensional shaped object 10. Further, when a liquid 2′ (colored ink) containing a pigment is used to manufacture the three-dimensional shaped object 10, the pigment can be suitably retained within the pores of the particles 11. Accordingly, it is possible to prevent undesired diffusion of the pigment, thus forming a high-resolution image in a more reliable manner.

Although the particles 11 may have any shape, it is preferable that they have a spherical shape. This can remarkably improve the fluidity of the layer-forming composition 1′ and the productivity of the three-dimensional shaped object 10, and more effectively prevent the formation of undesired irregularities or the like in the manufactured three-dimensional shaped object 10, thus remarkably improving the dimensional accuracy of the three-dimensional shaped object 10.

The layer-forming composition 1′ may contain a plurality of types of particles 11.

The content of the particles 11 in the layer-forming composition 1′ is preferably 8 mass % or more and 91 mass % or less, more preferably 10 mass % or more and 53 mass % or less.

This can achieve a sufficiently good fluidity of the layer-forming composition 1′, and remarkably improve the mechanical strength of the resulting final three-dimensional shaped object 10.

Solvent

The layer-forming composition 1′ contains a solvent 12.

This can remarkably improve the handleability (ease of handling) of the layer-forming composition 1′, easily form a layer 1 having higher uniformity in thickness, and effectively prevent undesired deformation of the layer 1. It is also possible to effectively prevent undesired penetration of the liquid 2′ into the layer 1 (layer 1 containing the solvent 12) in the first liquid application step, thus ensuring that the solidified part 2 formed in the first liquid application step has the desired shape. As described thus far, it is possible to remarkably improve the dimensional accuracy of the resulting final three-dimensional shaped object 10.

Examples of the solvent constituting the layer-forming composition 1′ include water; alcoholic solvents such as methanol, ethanol and isopropanol; ketone-based solvents such as methyl ethyl ketone and acetone; glycol ether-based solvents such as ethylene glycol monoethyl ether and ethylene glycol monobutyl ether; glycol ether acetate-based solvents such as propylene glycol 1-monomethyl ether 2-acetate and propylene glycol 1-monoethylether 2-acetate; polyethylene glycol, and polypropylene glycol. These may be used alone or in combination of two or more.

In particular, the layer-forming composition 1′ preferably contains an aqueous solvent, and more preferably contains water.

This can remarkably improve the fluidity of the layer-forming composition 1′ and the uniformity of the composition of the layer 1 formed by using the layer-forming composition 1′. In addition, water can be easily removed after the formation of the layer 1, and is less likely to cause an adverse effect even when it remains in the three-dimensional shaped object 10. Furthermore, water is also advantageous in terms of the safety for the human body and environmental issues, for example. When the liquid 2′ used to form the first solidified part 2A contains any of the above-described polymerizable compound (especially, an acrylic polymerizable compound, a silicone-based polymerizable compound), it is possible to more effectively prevent undesired penetration of the liquid 2′ into the layer 1 (the layer 1 containing the solvent 12), and more reliably form the first solidified part 2A having the desired shape, thus remarkably improving the dimensional accuracy and the reliability of the three-dimensional shaped object 10. When the layer-forming composition 1′ contains a water-soluble resin as a binder, which will be described in detail below, it is possible to bring the water-soluble resin into a more favorable dissolved state in the layer-forming composition 1′, and the effect achieved by inclusion of the binder (water-soluble resin) described below can be more effectively achieved.

The aqueous solvent may be any solvent that is highly soluble in water. Specifically, a solvent having a solubility (mass soluble in 100 g of water) in water at 25° C. of, for example, 30 [g/100 g water] or more, more preferably 50 [g/100 g water] or more.

The content of the solvent 12 in the layer-forming composition 1′ is preferably 9 mass % or more and 92 mass % or less, more preferably 29 mass % or more and 89 mass % or less.

This enables the effect provided by inclusion of the above-described solvent 12 to be exerted more prominently, and allows the solvent 12 to be easily removed in a short time in the manufacturing process of the three-dimensional shaped object 10, thus bringing an advantage from the viewpoint of improving the productivity of the three-dimensional shaped object 10.

In particular, the water content in the layer-forming composition 1′ is preferably 18 mass % or more and 92 mass % or less, more preferably 47 mass % or more and 90 mass % or less.

This enables the above-described effect to be more prominently exerted.

Binder

The layer-forming composition 1′ may contain a binder, in addition to the plurality of particles 11 and the solvent 12.

This allows the plurality of particles 11 to be suitably bound (fixed temporarily) in the layer 1 (especially, the layer 1 in the state in which the solvent 12 has been removed therefrom) formed by using the layer-forming composition 1′, thus effectively preventing undesired scattering or the like of the particles 11. Thereby, it is possible to further increase the safety for the operator and the dimensional accuracy of the manufactured three-dimensional shaped object 10.

When the layer-forming composition 1′ contains a binder, it is preferable that the binder is dissolved in the solvent 12 in the layer-forming composition 1′.

This can achieve a particularly favorable fluidity of the layer-forming composition 1′, and more effectively prevent undesired variations in the thickness of the layer 1 formed by using the layer-forming composition 1′. In addition, during the formation of the layer 1 in the state in which the solvent 12 has been removed therefrom, the binder can be attached to the particles 11 in higher uniformity throughout the layer 1, thus more effectively preventing undesired variations in composition. Accordingly, it is possible to more effectively prevent undesired variations in the mechanical strength of various areas of the resulting final three-dimensional shaped object 10, thus further enhancing the reliability of the three-dimensional shaped object 10.

Although it is possible to use any binder having the function of temporarily fixing the plurality of particles 11 in the layer 1 (especially, the layer 1 in the state in which the solvent 12 has been removed therefrom) formed by using the layer-forming composition 1′, a water-soluble resin can be preferably used.

When the layer-forming composition 1′ contains an aqueous solvent (especially, water) as the solvent 12, inclusion of a water-soluble resin allows the binder (water-soluble resin) to be contained in a dissolved state in the layer-forming composition 1′, thus making it possible to remarkably improve the fluidity and the handleability (ease of handling) of the layer-forming composition 1′. As a result, it is possible to remarkably improve the productivity of the three-dimensional shaped object 10.

An area of the layer 1 where the liquid 2′ is not applied in the manufacturing process of the three-dimensional shaped object 10 can be removed easily and efficiently by applying an aqueous solvent (especially, water). As a result, it is possible to remarkably improve the productivity of the three-dimensional shaped object 10. Further, the area of the layer that is supposed to be removed can be prevented from adhering to and remaining in the resulting final three-dimensional shaped object 10 in a simple and reliable manner, and it is therefore possible to remarkably improve the dimensional accuracy of the three-dimensional shaped object 10.

The following description will be focused on the water-soluble resin as the binder.

Although the water-soluble resin may be any resin as long as at least a portion of the resin is soluble in an aqueous solvent, the solubility of the resin (mass soluble in 100 g of water) in water at 25° C. is, for example, preferably 5 [g/100 g water] or more, more preferably 10 [g/100 g water] or more.

Examples of the water-soluble resin include synthetic polymers such as polyvinyl alcohol (PVA), polyvinyl pyrrolidone (PVP), polycaprolactone diol, sodium polyacrylate, polyacrylamide, modified polyamide, polyethylene imine, polyethylene oxide, and a random copolymer of ethylene oxide and propylene oxide; naturally-occurring polymers such as corn starch, mannan, pectin, agar, alginic acid, dextran, glue and gelatin; and semi-synthetic polymers such as carboxymethyl cellulose, hydroxyethyl cellulose, oxidized starch and modified starch. These may be used alone or in combination of two or more.

Specific examples of the water-soluble resin product include methylcellulose (METOLOSE SM-15 manufactured by Shin-Etsu Chemical Co., Ltd.), hydroxyethyl cellulose (AL-15 manufactured by FUJI Chemical Inc.), hydroxypropyl cellulose (HPC-M manufactured by Nippon Soda Co., Ltd.), carboxymethyl cellulose (CMC-30 manufactured by Nichirin Chemical Industries, Ltd.), sodium starch phosphate ester (I) (HOSTER 5100 manufactured by Matsutani Chemical Industry Co., Ltd.), polyvinyl pyrrolidone (PVP K-90 manufactured by Tokyo Chemical Industry Co., Ltd.), a methyl vinyl ether/maleic anhydride copolymer (AN-139 manufactured by GAF GANTREZ), polyacrylamide (manufactured by Wako Pure Chemical Industries, Ltd.), modified polyamide (modified nylon) (AQ nylon manufactured by Toray Industries, Inc.), polyethylene oxide (PEO-1 manufactured by Sumitomo Seika Chemicals Co., Ltd., ALKOX manufactured by Meisei Chemical Works, Ltd.), a random copolymer of ethylene oxide and propylene oxide (ALKOX EP manufactured by Meisei Chemical Works, Ltd.), sodium polyacrylate (manufactured by Wako Pure Chemical Industries, Ltd.), a carboxyvinyl polymer/cross-linked acrylic water-soluble resin (AQPEC manufactured by Sumitomo Seika Chemicals Company Limited).

In particular, when the water-soluble resin as the binder is polyvinyl alcohol, it is possible to remarkably improve the mechanical strength of the three-dimensional shaped object 10. Further, the properties of the binder (e.g., water solubility and water resistance) and the properties of the layer-forming composition 1′ (e.g., viscosity, the force of fixing the particles 11, and wettability) can be more suitably controlled by adjusting the degree of saponification and the degree of polymerization. Accordingly, it is possible to more suitably support the manufacture of a variety of three-dimensional shaped objects 10. Among various water-soluble resins, polyvinyl alcohol is inexpensive and its supply is stable. Accordingly, it is possible to manufacture the three-dimensional shaped object 10 in a stable manner, while suppressing the production cost.

When the water-soluble resin as the binder contains polyvinyl alcohol, the degree of saponification of the polyvinyl alcohol is preferably 85 or more and 90 or less. This can suppress a reduction in the solubility of the polyvinyl alcohol in an aqueous solvent (especially, water). Accordingly, it is possible to more effectively suppress a reduction in the adhesion between adjacent layers 1 when the layer-forming composition 1′ contains an aqueous solvent (especially, water).

When the water-soluble resin as the binder contains polyvinyl alcohol, the degree of polymerization of the polyvinyl alcohol is preferably 300 or more and 1000 or less. This can remarkably improve the mechanical strength of each layer 1 and the adhesion between adjacent layers 1 when the layer-forming composition 1′ contains an aqueous solvent (especially, water).

When the water-soluble resin as the binder is polyvinyl pyrrolidone (PVP), the following effect can be achieved. That is, polyvinyl pyrrolidone has excellent adhesion to various materials such as glass, metal and plastic, and thus can remarkably improve the strength and the shape stability of a portion of the layer 1 where the liquid 2′ is not applied, thereby remarkably improving the dimensional accuracy of the resulting final three-dimensional shaped object 10. In addition, polyvinyl pyrrolidone exhibits high solubility in various organic solvents, and thus can remarkably improve the fluidity of the layer-forming composition 1′ when the layer-forming composition 1′ contains an organic solvent, and favorably form a layer 1′ for which undesired variations in thickness has been effectively prevented, thereby remarkably improving the dimensional accuracy of the resulting final three-dimensional shaped object 10. Further, polyvinyl pyrrolidone exhibits high solubility in an aqueous solvent (especially, water) as well, and thus makes it possible to easily and reliably remove those of the particles 11 constituting each layer 1 that have not been bound by the resin material (binding agent) in the unbound particle removal step (after the end of shaping). Moreover, polyvinyl pyrrolidone has excellent affinity for various colorants, and thus makes it possible to effectively prevent undesired diffusion of a colorant when the liquid 2′ containing the colorant is used in the second liquid application step.

When the water-soluble resin as the binder contains polyvinyl pyrrolidone, the weight-average molecular weight of the polyvinyl pyrrolidone is preferably 10000 or more and 1700000 or less, more preferably 30000 or more and 1500000 or less.

This enables the above-described functions to be more effectively achieved.

When the water-soluble resin as the binder contains polycaprolactone diol, the weight-average molecular weight of the polycaprolactone diol is preferably 10000 or more and 1700000 or less, more preferably 30000 or more and 1500000 or less.

This enables the above-described functions to be more effectively achieved.

Preferably, the binder exhibits a liquid state (e.g., dissolved state, molten state) in the layer-forming composition 1′ in the layer forming step. Thereby, the uniformity in the thickness of the layer 1 formed by using the layer-forming composition 1′ can be further increased in a simple and reliable manner.

When the layer-forming composition 1′ contains a binder, the binder content in the layer-forming composition 1′ is preferably 0.5 mass % or more and 25 mass % or less, more preferably 1.0 mass % or more and 10 mass % or less.

This enables the above-described effect provided by inclusion of the binder to be exerted more prominently, and can provide a sufficiently high content of the particles 11 or the like in the layer-forming composition 1′, thus making it possible to remarkably improve the mechanical strength and the like of the manufactured three-dimensional shaped object 10.

Other Components

The layer-forming composition may contain components other than those described above. Examples of such components include a polymerization initiator; a polymerization accelerator; a penetration enhancer; a humectant (moisturizer); a fixing agent; an antifungal agent; an antiseptic agent; an antioxidant; an ultraviolet absorber; a chelating agent; and a pH controlling agent.

Three-Dimensional Shaped Object

A three-dimensional shaped object according to the invention is manufactured by using the above-described manufacturing method according to the invention.

Accordingly, it is possible to provide a three-dimensional shaped object having an excellent dimensional accuracy.

Examples of the uses of the three-dimensional shaped object according to the invention include, but are not particularly limited to, ornamental objects and exhibits such as dolls and figures; and medical devices such as implants.

The three-dimensional shaped object of the invention may be applied to any of a prototype, a mass-produced article, and a custom-made article.

Although a preferred embodiment of the invention has been described above, the invention is not limited thereto.

For example, although the above embodiment has been described assuming that the solidified part is formed in all layers, the three-dimensional shaped object may include a layer in which no solidified part is formed. For example, the layer formed directly above the stage may have no solidified part formed therein, and may function as a sacrificial layer.

Although the description of the above embodiment is focused on a case where the layer forming step, the first liquid application step, the solvent removal step, and the second liquid application step are repeated as a series of steps, the series of steps to be repeated may be different in each cycle. For example, there may be a cycle in which the first liquid application step has been omitted from the above-described steps, or there may be a cycle in which the second liquid application step has been omitted.

For example, when the liquid used to form the solidified part contains a polymerizable compound, the curing treatment performed for forming each solidified part (cured part) may not be repeated each time a pattern corresponding to the solidified part (cured part) is formed, and may be performed collectively after forming a laminate in which uncured patterns are provided in a plurality of layers, for example.

Although the above embodiment has described a representative case where the second solidified part (solidified part formed by the liquid applied in the second liquid application step) and the third solidified part (solidified part formed by the liquid applied in the third liquid application step) are formed in addition to the solidified part (solidified part formed by the liquid applied in the first liquid application step), the second solidified part and the third solidified part need not be formed in the invention.

According to the invention, the three-dimensional shaped object may contain particles that are not bound by a resin material.

Although the above embodiment has mainly described a case where the liquid used to form the solidified part is applied by an ink jet method, the liquid used to form the solidified part may be applied by a different method (e.g., a different printing method).

In the manufacturing method of the invention, a pretreatment step, an intermediate treatment step, and an aftertreatment step may be performed as needed.

Examples of the pretreatment step include a stage cleaning step.

Examples of the aftertreatment step include a washing step, a shape adjustment step of performing deburring or the like, a coloring step, a coating layer forming step, and a resin material curing completion step of performing a light irradiation treatment or a heat treatment for reliably curing an uncured resin material.

The above embodiment has described a case where the solidified part (first solidified part) formed in the first liquid application step constitutes a part of the intended three-dimensional shaped object. However, according to the invention, the first solidified part may not constitute a part of the three-dimensional shaped object, but may be eventually removed. In other words, the first solidified part may function as a support material during manufacture of the three-dimensional shaped object. Even in such a case, as a result of controlling the thickness and the like of the first solidified part in a reliable manner, it is possible to reliably form the second solidified part constituting the intended three-dimensional shaped object so as to have a suitable shape, thus remarkably improving the dimensional accuracy of the three-dimensional shaped object.

In such a case, the first solidified part may be removed, for example, immediately after the end of shaping, but may be removed by the user at the time of use (after purchase) since it functions as a protective film for protecting the three-dimensional shaped object at the time of display, sale and the like.

When the first solidified part is removed eventually, examples of combinations of the material constituting the first solidified part and the material constituting the second solidified part for facilitating easy removal of the first solidified part include a combination of a thermoplastic resin and a curable resin and a combination of a resin material having high solubility in a predetermined solvent and a resin material having low solubility in the predetermined solvent (more preferably, an insoluble resin material).

The entire disclosure of Japanese Patent Application No. 2014-212386, filed Oct. 17, 2014 is expressly incorporated by reference herein.

What is claimed is:

1. A three-dimensional shaped object manufacturing method for manufacturing a three-dimensional shaped object by laminating layers, comprising:
a layer forming step of forming each of the layers by using a layer-forming composition containing particles and a solvent;
a first liquid application step of applying, onto the layer in a state of containing the solvent, a liquid used to form a solidified part; and
a solvent removal step of removing the solvent from the layer.

2. The three-dimensional shaped object manufacturing method according to claim 1,
wherein at least a portion of the solidified part formed on a surface of an nth layer from below is embedded in an (n+1)th layer from below in the layer forming step performed after the first liquid application step for forming the solidified part (where n is an integer of 1 or more).

3. The three-dimensional shaped object manufacturing method according to claim 1,
wherein, in the first liquid application step, the liquid is applied to a surface of the layer containing the solidified part, in a region containing an area that does not overlap the solidified part when the layer is seen in plan view.

4. The three-dimensional shaped object manufacturing method according to claim 1, further comprising,
after the solvent removal step, a second liquid application step of applying a liquid that is used to form a solidified part to the layer in a state in which the solvent has been removed therefrom, so as to allow the liquid to penetrate into the layer.

5. The three-dimensional shaped object manufacturing method according to claim 1, further comprising
a third liquid application step of applying, onto a stage on which the layer is not formed, a liquid that is used to form a solidified part.

6. The three-dimensional shaped object manufacturing method according to claim 1,
wherein the layer-forming composition contains an aqueous solvent as the solvent.

7. The three-dimensional shaped object manufacturing method according to claim 1,
wherein the layer-forming composition contains a binder, in addition to the particles and the solvent.

8. The three-dimensional shaped object manufacturing method according to claim 1,
wherein the liquid contains a curable resin.

9. The three-dimensional shaped object manufacturing method according to claim 1,
wherein the liquid contains an acrylic polymerizable compound.

10. The three-dimensional shaped object manufacturing method according to claim 1,
wherein the liquid contains a silicone-based polymerizable compound.

11. A three-dimensional shaped object manufactured by using the three-dimensional shaped object manufacturing method according to claim 1.
